(19) United States
(12) Patent Application Publication
(10) Pub. No.: US 2011/0242253 A1
(43) Pub. Date: Oct. 6, 2011

(54) OPTICAL HEAD, IMAGE FORMING APPARATUS, AND MANUFACTURING OF THE OPTICAL HEAD

(75) Inventors: Kazutoshi Takahashi, Shizuoka-ken (JP); Koji Tanimoto, Shizuoka-ken (JP); Kenichi Komiya, Kanagawa-ken (JP); Daisuke Ishikawa, Shizuoka-ken (JP); Hiroyuki Ishikawa, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/069,289

(22) Filed: Mar. 22, 2011

Related U.S. Application Data
(60) Provisional application No. 61/320,288, filed on Apr. 1, 2010.
(60) Provisional application No. 61/320,291, filed on Apr. 1, 2010.

(51) Int. Cl. B41J 2/385; C09J 5/00; G02B 13/14; G02B 7/02

(52) U.S. Cl. 347/118; 359/811; 359/355; 156/305

(57) ABSTRACT

According to one embodiment, an optical head includes a light emitting substrate emitting light and allow light of specific wavelength to pass; a mounting base to which the light emitting substrate is fixed and which includes a groove formed in an area overlapping the light emitting substrate; an adhesive filled in the groove of the mounting base and cured by receiving the light having the specific wavelength; and a lens condensing the light emitted from the light emitting substrate.

### CROSS-REFERENCE TO RELATED APPLICATION(S)

This application is based upon and claims the benefit of priority from: U.S. provisional application 61/320288, filed on Apr. 1, 2010; and U.S. provisional application 61/320291, filed on Apr. 1, 2010; the entire contents all of which are incorporated herein by reference.

### FIELD

Embodiments described herein relate generally to an optical head, an image forming apparatus, and manufacturing of the optical head.

### BACKGROUND

An optical head emits light used for exposure of a photoconductive member. The optical head includes a light emitting substrate. The light emitting substrate generates heat according to the emission of the light. It is possible to allow the heat of the light emitting substrate to escape to a mounting base by fixing the light emitting substrate to the mounting base. If there is a space between the light emitting substrate and the mounting base, the heat of the light emitting substrate less easily escapes to the mounting base.

### DESCRIPTION OF THE DRAWINGS

FIG. 1 is a diagram of the internal structure of an image forming apparatus;

FIG. 2 is a sectional view of an optical printer head according to a first embodiment;

FIG. 3 is a disassembled diagram of a light emitting substrate and a mounting base in the first embodiment;

FIG. 4 is a diagram for explaining a method of fixing the light emitting substrate and the mounting base;

FIG. 5 is a diagram for explaining the method of fixing the light emitting substrate and the mounting base;

FIG. 6 is a diagram for explaining the method of fixing the light emitting substrate and the mounting base;

FIG. 7 is a diagram for explaining the method of fixing the light emitting substrate and the mounting base;

FIG. 8 is a diagram for explaining the method of fixing the light emitting substrate and the mounting base;

FIG. 9 is a diagram of a part of a mounting base in a modification of the first embodiment;

FIG. 10 is a sectional view taken along line A-A shown in FIG. 9;

FIG. 11 is an external view of a light emitting substrate and a mounting base in a second embodiment;

FIG. 12 is an enlarged view of a part of the light emitting substrate and the mounting base in the second embodiment;

FIG. 13 is an external view of a jig for adjusting the height of blocks of the mounting base;

FIG. 14 is a diagram for explaining a method of adjusting the height of the block;

FIG. 15 is a diagram for explaining the method of adjusting the height of the block;

FIG. 16 is a diagram for explaining the method of adjusting the height of the block;

FIG. 17 is a diagram for explaining a method of attaching the light emitting substrate to the block;

FIG. 18 is a diagram for explaining the method of attaching the light emitting substrate to the block; and

FIG. 19 is a diagram for explaining the method of attaching the light emitting substrate to the block.

### DETAILED DESCRIPTION

In general, according to one embodiment, an optical head includes a light emitting substrate emitting light and allow light of specific wavelength to pass; a mounting base to which the light emitting substrate is fixed and which includes a groove formed in an area overlapping the light emitting substrate; an adhesive filled in the groove of the mounting base and cured by receiving the light having the specific wavelength; and a lens condensing the light emitted from the light emitting substrate.

### First Embodiment

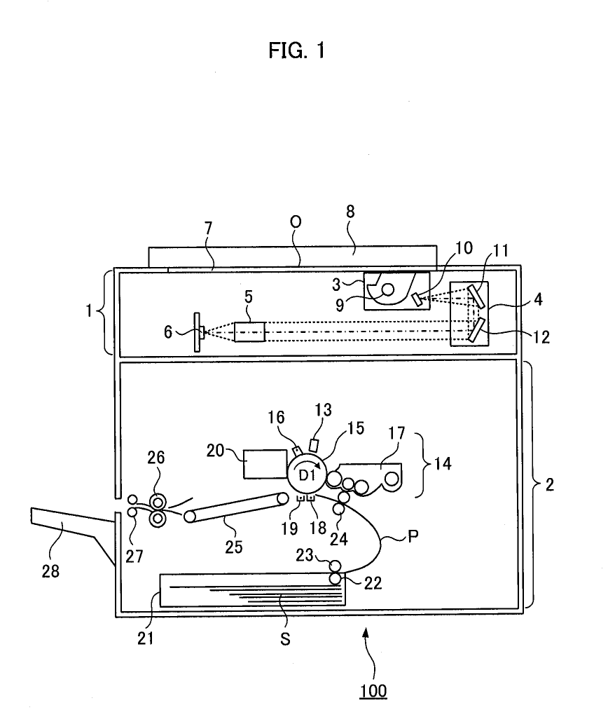

FIG. 1 is a diagram of the internal structure of an image forming apparatus. An image forming apparatus 100 includes a scanner unit 1 and a printer unit 2. The scanner unit 1 reads an image of an original document O. The printer unit 2 forms an image on a sheet.

The original document O is placed on a document table glass 7. A reading surface of the original document O is in contact with the document table glass 7. A cover 8 rotates between a position where the cover 8 closes the document table glass 7 and a position where the cover 8 opens the document table glass 7. If the cover 8 closes the document table glass 7, the cover 8 presses the original document O against the document table glass 7.

Alight source 9 emits light toward the original document O. The light of the light source 9 is transmitted through the document table glass 7 and reaches the original document 0. Reflected light from the original document O is reflected by mirrors 10, 11, and 12 in this order and led to a condenser lens 5. The condenser lens 5 condenses the light from the mirror 12 and focuses the light on a light receiving surface of a photoelectric conversion element 6. The photoelectric conversion element 6 receives the light from the condenser lens 5 and converts the light into an electric signal (an analog signal).

An output signal of the photoelectric conversion element 6 is output to an optical printer head 13, which is an optical head, after being subjected to predetermined signal processing. The predetermined signal processing is processing for generating image data (digital data) of the original document O. As the photoelectric conversion element 6, for example, a CCD sensor or a CMOS sensor can be used.

A first carriage 3 supports the light source 9 and the mirror 10 and moves along the document table glass 7. A second carriage 4 supports the mirrors 11 and 12 and moves along the document table glass 7. The first carriage 3 and the second carriage 4 move independently from each other and maintain constant optical path length from the original document 0 to the photoelectric conversion element 6.

When the image of the original document O is read, the first carriage 3 and the second carriage 4 move in one direction. While the first carriage 3 and the second carriage 4 move in the one direction, the light source 9 emits the light on the original document O. The reflected light from the original document O is focused on the photoelectric conversion element 6 by the mirrors 10 to 12 and the condenser lens 5. The image of the original document O is sequentially read line by line in the moving direction of the first carriage 3 and the second carriage 4.

The printer unit 2 includes an image forming unit 14. The image forming unit 14 forms an image on a sheet S conveyed from a paper feeding cassette 21. Plural sheets S stored in the paper feeding cassette 21 are separated one by one by a conveying roller 22 and a separating roller 23 and conveyed to the image forming unit 14. The sheet S reaches a registration roller 24 while moving on a conveying path P. The registration roller 24 moves the sheet S to a transfer position of the image forming unit 14 at predetermined timing.

A conveying mechanism 25 moves the sheet S having the image formed thereon by the image forming unit 14 to a fixing device 26. The fixing device 26 heats the sheet S to thereby fix the image on the sheet S. A paper discharge roller 27 moves the sheet S having the image fixed thereon to a paper discharge tray 28.

The operation of the image forming unit 14 is explained below.

The optical printer head 13, a charging device 16, a developing device 17, a transfer charger 18, a peeling charger 19, and a cleaner 20 are arranged around a photoconductive drum 15. The photoconductive drum 15 rotates in a direction of an arrow D1.

The charging device 16 charges the surface of the photoconductive drum 15. The optical printer head 13 exposes the charged photoconductive drum 15 to light. The optical printer head 13 causes plural light beams to reach an exposure position of the photoconductive drum 15.

When the light beams from the optical printer head 13 reach the photoconductive drum 15, the potential in an exposed section falls and an electrostatic latent image is formed. The developing device 17 supplies a developer to the surface of the photoconductive drum 15 and forms a developer image on the surface of the photoconductive drum 15.

When the developer image reaches a transfer position according to the rotation of the photoconductive drum 15, the transfer charger 18 transfers the developer image on the photoconductive drum 15 onto the sheet S. The peeling charger 19 peels the sheet S off the photoconductive drum 15. The cleaner 20 removes the developer remaining on the surface of the photoconductive drum 15.

While the photoconductive drum 15 is rotating, formation of an electrostatic latent image, formation of a developer image, transfer of the developer image, and cleaning of the remaining developer image can be continuously performed. In other words, it is possible to continuously perform the operation for forming images on the sheet S.

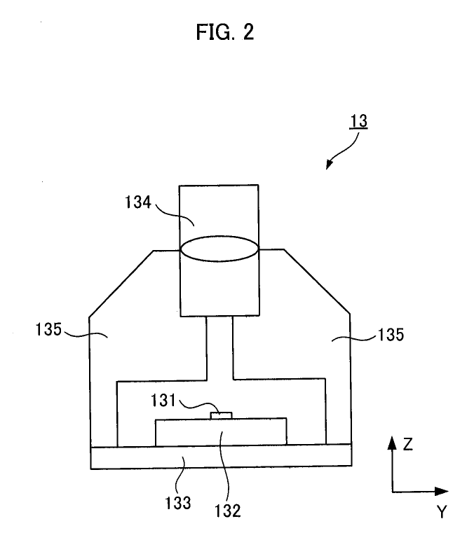

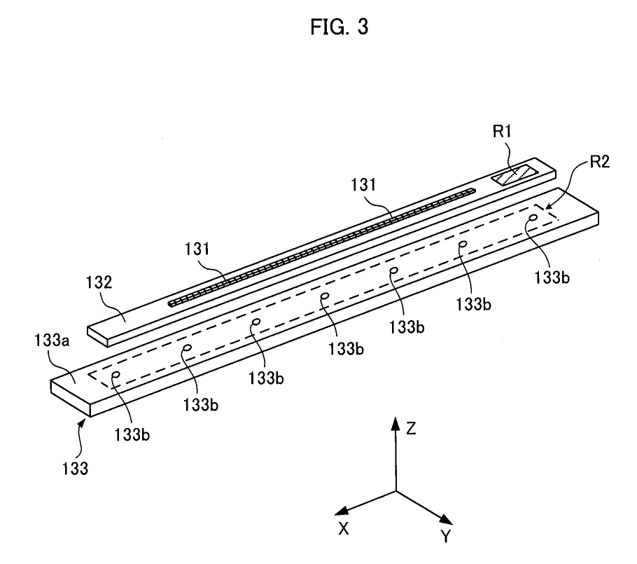

The structure of the optical printer head 13 is specifically explained with reference to FIGS. 2 and 3. FIG. 2 is a sectional view of the optical printer head 13. FIG. 3 is a disassembled diagram of a light emitting substrate and a mounting base. In FIGS. 2 and 3, an X axis, a Y axis, and a Z axis are axes orthogonal to one another. In other figures, a relation among the X axis, the Y axis, and the Z axis is the same.

As shown in FIG. 3, a light emitting substrate 132 extends in an X direction and has plural light emitting points 131. The plural light emitting points 131 are provided on the front surface of the light emitting substrate 132 and arranged in a longitudinal direction of the light emitting substrate 132 (the X direction). The front surface of the light emitting substrate 132 is a flat surface.

For example, if the resolution of an image formed by the image forming unit 14 is 1200 dpi, 1200 light emitting points 131 can be provided per one inch. In this embodiment, the plural light emitting points 131 are arranged in one row. However, the plural light emitting points 131 can be arranged in plural rows.

As the light emitting point 131, for example, an organic electroluminescence element or an LED (Light Emitting Diode) can be used. The light emitting substrate 132 can be formed of glass. The light emitting substrate 132 has an area R1 to which a wire is connected. The wire sends a driving signal of the light emitting point 131. When the light emitting point 131 emits light, in some cases, heat is generated and accumulated in the light emitting substrate 132.

A mounting base 133 supports the light emitting substrate 132. The mounting base 133 can be formed of, for example, resin or metal. The mounting base 133 is in contact with the rear surface of the light emitting substrate 132. The rear surface of the light emitting substrate 132 is a flat surface. A surface 133a of the mounting base 133 in contact with the light emitting substrate 132 is also a flat surface. If the mounting base 133 is formed of metal, it is easy to allow heat generated in the light emitting substrate 132 during light emission of the light emitting points 131 to escape to the mounting base 133.

The mounting base 133 has plural grooves 133b on the surface 133a in contact with the light emitting substrate 132. The plural grooves 133b are arranged in the longitudinal direction of the mounting base 133 (the X direction). An adhesive is filled in the grooves 133b. As the adhesive, an adhesive cured by receiving the emission of an ultraviolet ray is used.

The plural grooves 133b are provided on the inner side of an area R2. The area R2 is an area where the light emitting substrate 132 overlaps the mounting base 133. The grooves 133b only have to be provided on the inner side of the area R2. The number, position, and size of the grooves 133b can be set as appropriate. The size of the grooves 133b is an opening area of the grooves 133b.

Only one groove 133b may be provided. When the one groove 133b is provided, it is desirable to provide the groove 133b in the center of the area R2 in the longitudinal direction of the light emitting substrate 132 (the X direction). The adhesive is not always filled in the grooves 133b. The adhesive can be applied along the edge of the light emitting substrate 132, in other words, the outer edge of the area R2.

As shown in FIG. 2, the light emitted from the light emitting point 131 is made incident on a Selfoc lens array 134. The Selfoc lens array 134 includes plural Selfoc lenses. The plural Selfoc lenses are arranged along the longitudinal direction of the light emitting substrate 132 (the X direction). Lights emitted from the light emitting points 131 are made incident on the Selfoc lenses corresponding to the light emitting points 131.

The Selfoc lens array 134 condenses plural lights (diffused lights) from the plural light emitting points 131 and causes the lights to reach the exposure position of the photoconductive drum 15. In the exposure position, spot light having desired resolution is formed. A lens holder 135 holds the Selfoc lens array 134.

A method of fixing the light emitting substrate 132 and the mounting base 133 is explained below.

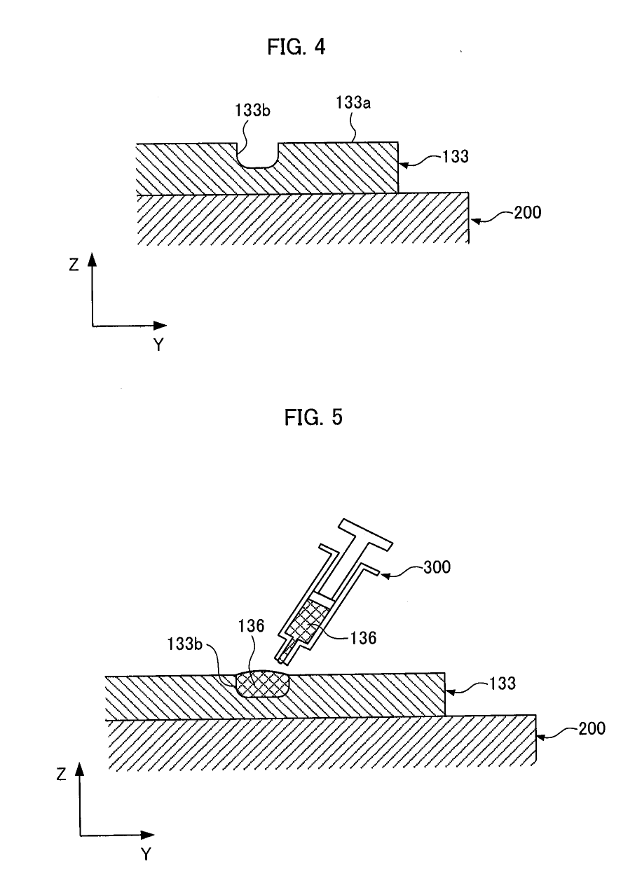

As shown in FIG. 4, the mounting base 133 is fixed to a workbench 200. As shown in FIG. 5, an adhesive 136 is filled in the groove 133b of the mounting base 133 using a dispenser 300. The adhesive 136 is filled to fit in the groove 133b. Since the mounting base 133 has the plural grooves 133b, the adhesive 136 is filled in the grooves 133b.

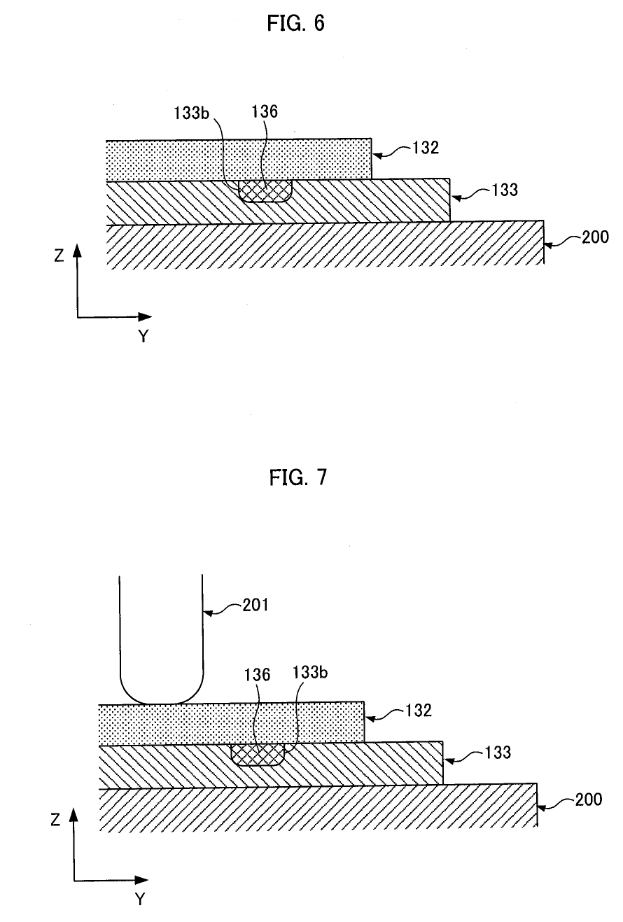

As shown in FIG. 6, the light emitting substrate 132 is placed on the mounting base 133. The adhesive 136 comes into contact with the light emitting substrate 132. As shown in FIG. 7, the light emitting substrate 132 is pressed against the mounting base 133 using a jig 201. This allows the adhesive 136 to easily come into contact with the light emitting substrate 132.

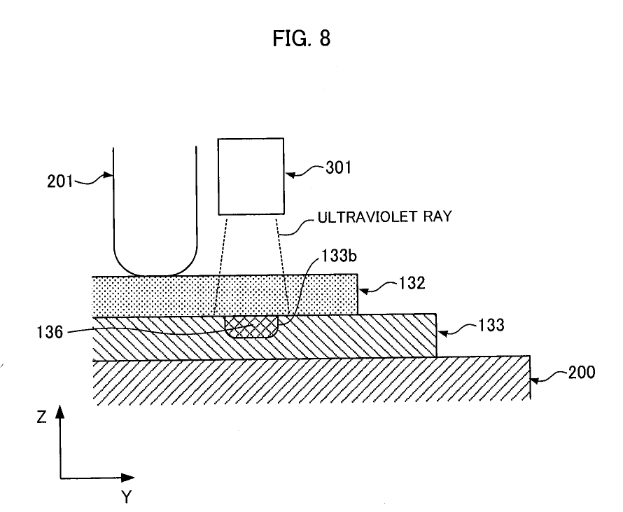

As shown in FIG. 8, in a state in which the jig 201 presses the light emitting substrate 132 against the mounting base 133, an ultraviolet ray emitter 301 emits an ultraviolet ray toward the adhesive 136. The emission of the ultraviolet ray is applied to the adhesive 136 filled in the grooves 133b. The ultraviolet ray emitted from the ultraviolet ray emitter 301 passes through the light emitting substrate 132 and reaches the adhesive 136.

The light emitting substrate 132 is formed of glass and can allow the ultraviolet ray to pass. The light emitting substrate 132 only has to be capable of allowing the ultraviolet ray to pass. A material of the light emitting substrate 132 can be selected as appropriate.

The adhesive 136 can fix the light emitting substrate 132 to the mounting base 133 by being cured by receiving the ultraviolet ray. Even if the jig 201 is removed, the light emitting substrate 132 does not move with respect to the mounting base 133. An emission time and emission range of the ultraviolet ray can be set as appropriate taking into account sufficient curing of the adhesive 136.

According to this embodiment, it is possible to fix the light emitting substrate 132 to the mounting base 133 using the adhesive 136 filled in the grooves 133b. Since the adhesive 136 is present in the area R2 (see FIG. 3) overlapping the light emitting substrate 132 in the mounting base 133, it is easy to fix the light emitting substrate 132 along the mounting base 133.

Since the light emitting substrate 132 is fixed along the mounting base 133, it is possible to suppress the light emitting substrate 132 from bending. If the bending of the light emitting substrate 132 is suppressed, it is possible to prevent the plural light emitting points 131 from shifting in an emitting direction of light (a Z direction).

If the positions of the plural light emitting points 131 shift in the Z direction, it is likely that a light condensing characteristic by the Selfoc lens array 134 changes and fluctuation occurs in the exposure position of the photoconductive drum 15. In this embodiment, it is possible to align optical path lengths from the plural light emitting points 131 to the exposure position of the photoconductive drum 15 and suppress fluctuation in the exposure position.

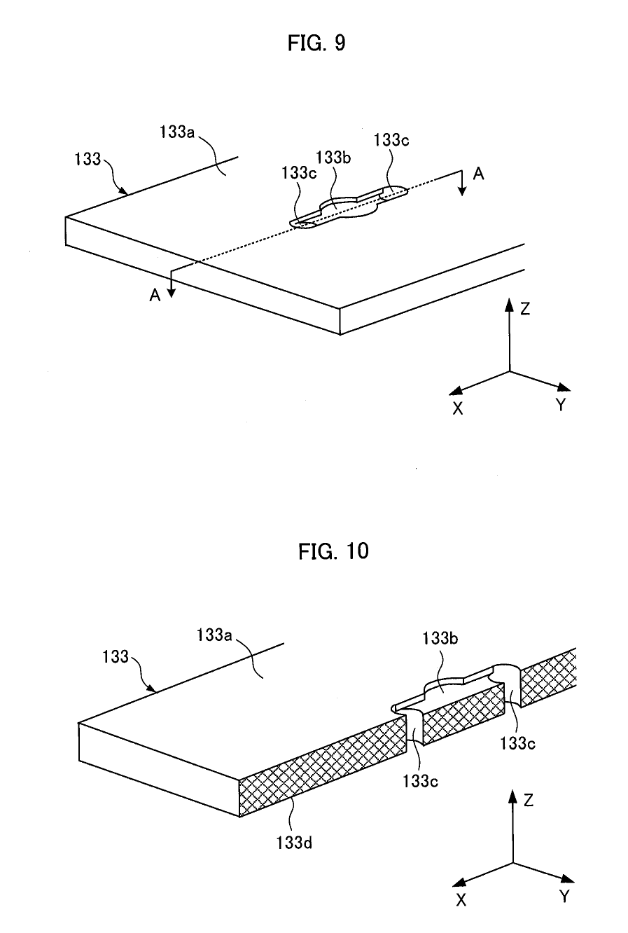

As a modification of this embodiment, the mounting base 133 shown in FIGS. 9 and 10 can be used. FIG. 9 is an external view of a part of the mounting base. FIG. 10 is a sectional view taken along line A-A shown in FIG. 9.

The mounting base 133 has a groove 133b and two through holes 133c connected to the groove 133b. The through holes 133c extend in the thickness direction of the mounting base 133 (the Z direction). One end of the through hole 133c is linked to the groove 133b. The other end of the through hole 133c is exposed on a rear surface 133d of the mounting base 133.

One through hole 133c of the two through holes 133c can be used to fill the adhesive 136 in the groove 133b. The other through hole 133c can be used to discharge, from the mounting base 133, the adhesive 136 overflowing from the groove 133b.

The number of the through holes 133c can be selected as appropriate. One end of the through hole 133c only has to be linked to the groove 133b and the other end of the through hole 133c only has to be exposed on the outer surface of the mounting base 133. Only one through hole 133c may be provided.

When the mounting base 133 shown in FIGS. 9 and 10 is used, the light emitting substrate 132 is placed on the mounting base 133 in advance. The light emitting substrate 132 closes the groove 133b of the mounting base 133. It is desirable to press the light emitting substrate 132 against the mounting base 133 using the jig 201 to prevent the light emitting substrate 132 from shifting from the mounting base 133.

In a state in which the light emitting substrate 132 is placed on the mounting base 133, the adhesive 136 is filled in the groove 133b from one through hole 133c. When the groove 133b is filled with the adhesive 136, the adhesive 136 overflowing from the groove 133b moves to the other through hole 133c and is discharged to the outside of the mounting base 133.

The light emitting substrate 132 can be fixed to the mounting base 133 by emitting an ultraviolet ray on the adhesive 136 filled in the groove 133b to cure the adhesive 136.

With the configuration shown in FIGS. 9 and 10, since the light emitting substrate 132 closes the groove 133b, it is easy to fill the adhesive 136 only in the groove 133b.

### Second Embodiment

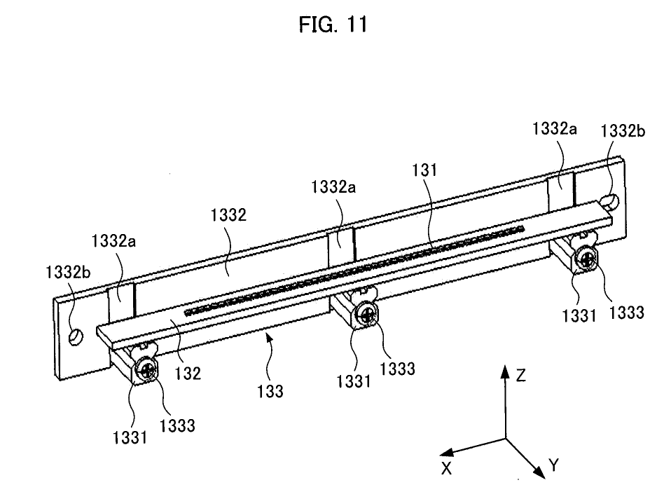

FIG. 11 is an external view of a light emitting substrate and a mounting base in a second embodiment.

The light emitting substrate 132 has the plural light emitting points 131. The mounting base 133 includes three blocks 1331 and a supporting plate 1332 supports the three blocks 1331. The blocks 1331 extend in a direction orthogonal to the supporting plate 1332 (a Y direction).

The supporting plate 1332 has three guide grooves 1332a extending in the Z direction. The blocks 1331 move along the guide grooves 1332a. This makes it possible to adjust the position (the height) of the light emitting substrate 132 in the Z direction.

Screws 1333 pierce through the blocks 1331 and the supporting plate 1332. Distal ends of the screws 1333 mesh with nuts. If the screws 1333 rotate in one direction, the heads of the screws 1333 and the nuts hold the blocks 1331 and the supporting plate 1332. The blocks 1331 can be fixed to the supporting plate 1332. If the screws 1333 rotate in the other direction, a space between the heads of the screws 1333 and the nuts widens. The blocks 1331 can move along the guide grooves 1332a.

The supporting plate 1332 has holes 1332b at both ends in a longitudinal direction of the supporting plate 1332. The holes 1332b are used to attach the supporting plate 1332 to a jig.

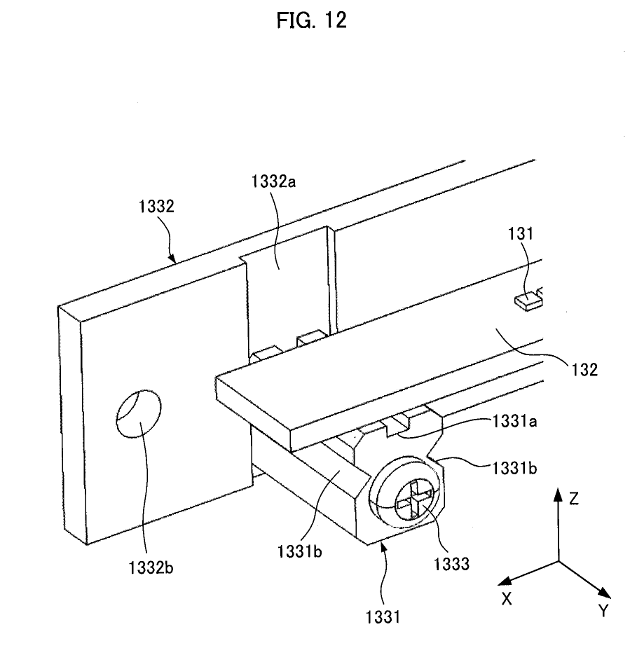

As shown in FIG. 12, the block 1331 has a groove 1331a on a surface in contact with the light emitting substrate 132. The groove 1331a extends in a longitudinal direction of the block 1331 (the Y direction) and overlaps the light emitting substrate 132. An adhesive is filled in the groove 1331a. As the adhesive, an adhesive cured by receiving an ultraviolet ray can be used.

The block 1331 includes two cutouts 1331b. The cutouts 1331b extend in the longitudinal direction of the block 1331 (the Y direction). The cutouts 1331b are used to adjust the position of the block 1331 in the Z direction.

In this embodiment, the three blocks 1331 support the light emitting substrate 132. However, the number of the blocks 1331 only has to be equal to or larger than two. For example, when two blocks 1331 are used, the two blocks 1331 can support both end sides of the light emitting substrate 132.

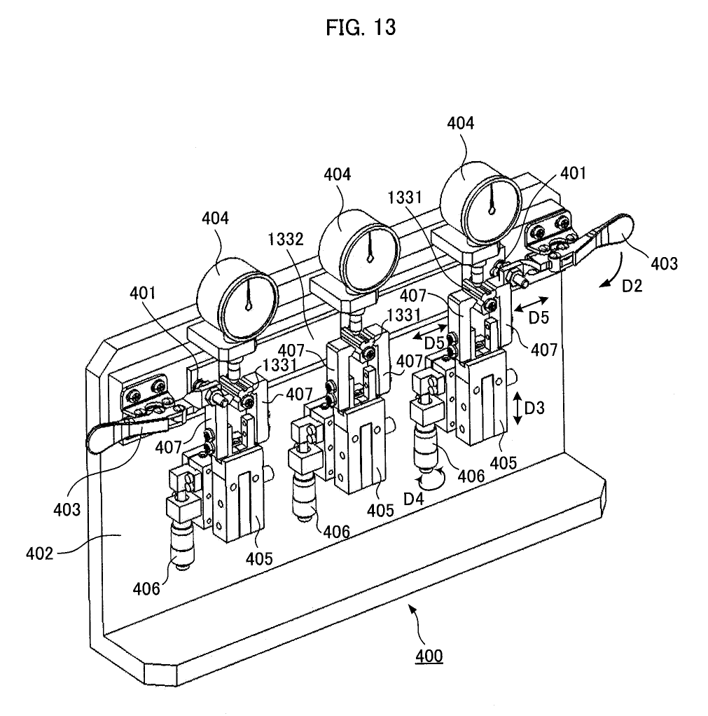

FIG. 13 is a diagram of a jig 400 for adjusting the height of the light emitting substrate 132. The jig 400 includes pins 401. The pins 401 are inserted into the holes 1332b of the supporting plate 1332. The pins 401 enter the holes 1332b, whereby the supporting plate 1332 can be positioned with respect to a frame 402 of the jig 400.

Clamps 403 are used to press the supporting plate 1332 against the frame 402. When the clamps 403 are located in positions shown in FIG. 13, the supporting plate 1332 is pressed against the frame 402. If the clamps 403 rotate in a direction of an arrow D2, the supporting plate 1332 can be removed from the frame 402.

The jig 400 includes three dial gauges 404. The dial gauges 404 are provided to correspond to the blocks 1331 of the mounting base 133. The dial gauges 404 are used to measure the position (the height) of the blocks 1331 in the Z direction.

Stages 405 move in a direction of an arrow D3 with respect to the frame 402. Grips 406 can rotate in a direction of an arrow D4. The grips 406 are operated to move the stages 405 in the direction of the arrow D3. The grips 406 and the stages 405 are connected via a power transmitting mechanism. The power transmitting mechanism converts operation force of the grips 406 into driving force for the stages 405.

If the grips 406 rotate in one direction, the stages 405 move upward. If the grips 406 rotate in the other direction, the stages 405 move downward.

A pair of chucks 407 are attached to the stage 405 and move according to the movement of the stages 405. The pair of chucks 407 move in a direction of an arrow D5 and a space between the pair of chucks 407 changes. When the space between the pair of chucks 407 is narrowed, the distal ends of the chucks 407 engage with the cutouts 1331b of the block 1331. When the chucks 407 engage with the cutouts 1331b, if the stage 405 moves in the direction of the arrow D3, the height of the block 1331 can be adjusted.

The grips 406 corresponding to the three blocks 1331 are operated to adjust the height of the blocks 1331. This makes it possible to align the heights of the three blocks 1331.

A method of fixing the light emitting substrate 132 to the mounting base 133 is explained below. The mounting base 133 is attached to the jig 400 in advance.

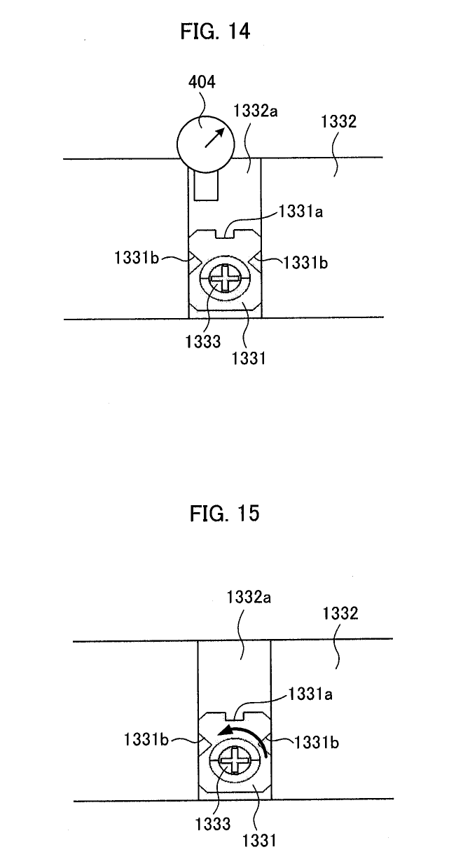

As shown in FIG. 14, the height of the block 1331 is measured using the dial gauge 404. The measurement of the height is performed for the three blocks 1331.

If the heights of the three blocks 1331 are different, adjustment of the heights of the blocks 1331 is performed. The pair of chucks 407 engage with the cutouts 1331b of each of the blocks 1331. As shown in FIG. 15, the fixing of the block 1331 to the supporting plate 1332 is released by rotating the screw 1333 in one direction. When the fixing of the block 1331 is released, the block 1331 can move along the guide groove 1332a of the supporting plate 1332.

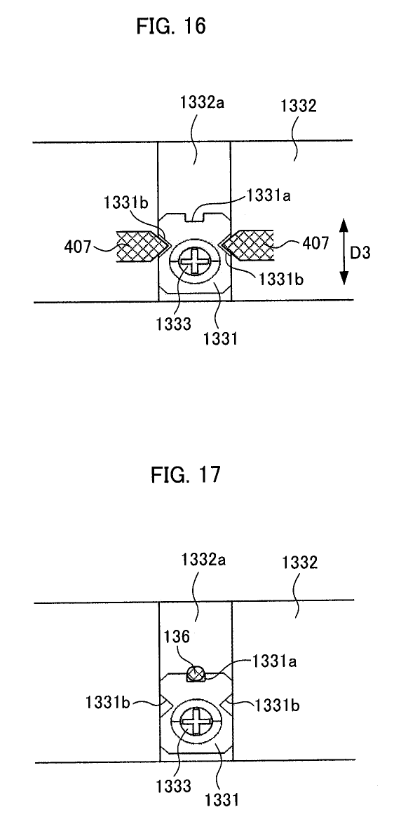

The stage 405 is driven by operating the grip 406. As shown in FIG. 16, the block 1331 held between the pair of chucks 407 moves according to the movement of the stage 405. If the heights of the three blocks 1331 are aligned, the block 1331 is fixed to the supporting plate 1332 by rotating the screw 1333

As shown in FIG. 17, the adhesive 136 is filled in the groove 1331a of the block 1331. The adhesive 136 fills the groove 1331a.

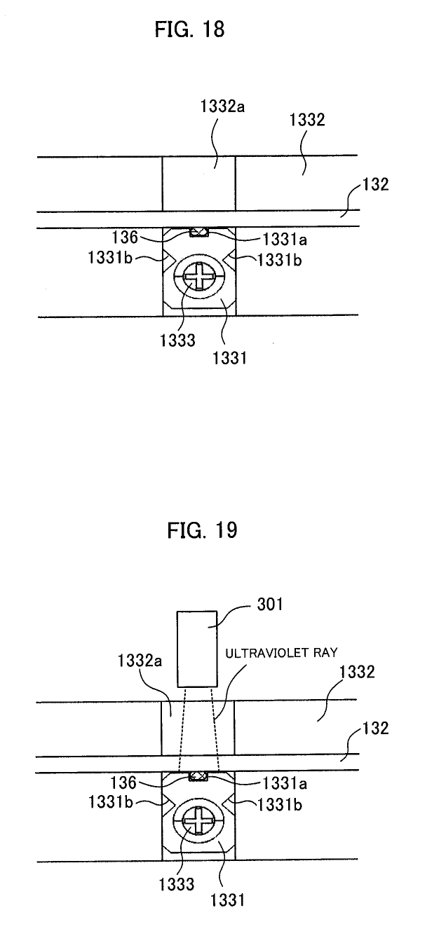

As shown in FIG. 18, the light emitting substrate 132 is placed on the block 1331. The adhesive 136 comes into contact with the light emitting substrate 132. If the light emitting substrate 132 is pressed against the block 1331, it is easy to bring the adhesive 136 into contact with the light emitting substrate 132.

As shown in FIG. 19, the ultraviolet ray emitter 301 emits an ultraviolet ray from above the light emitting substrate 132. The ultraviolet ray emitted from the ultraviolet ray emitter 301 passes through the light emitting substrate 132 and reaches the adhesive 136. The adhesive 136 is cured by receiving the emission of the ultraviolet ray. When the adhesive 136 is cured, the light emitting substrate 132 is fixed to the block 1331.

In this embodiment, the ultraviolet ray passes through the light emitting substrate 132 and reaches the adhesive 136. This makes it possible to cure the adhesive 136 present in an area where the light emitting substrate 132 and the block 1331 overlap each other. It is possible to arrange the light emitting substrate 132 along a plane by aligning the heights of the three blocks 1331. It is possible to align optical path lengths from the plural light emitting points 131 to the photoconductive drum 15 by arranging the light emitting substrate 132 along the plane.

In this embodiment, the blocks 1331 move with respect to the supporting plate 1332. However, it is possible to integrally form the blocks 1331 and the supporting plate 1332.

In the embodiments explained above, the adhesive 136 only has to be cured by receiving emission of light. The wavelength of the light only has to be changed according to a curing characteristic of the adhesive 136. As the adhesive 136, for example, an adhesive cured by receiving visible light can be used.

While certain embodiments have been described, these embodiments have been presented by way of example only, and are not intended to limit the scope of invention. Indeed, the novel embodiments described herein may be embodied in a variety of other forms; furthermore, various omissions, substitutions and changes in the form of the embodiments described herein may be made without departing from the sprit of the inventions. The accompanying claims and their equivalents are intended to cover such forms or modifications as would fall within the scope and spirit of the inventions.

What is claimed is:

1. An optical head comprising:
a light emitting substrate emitting light and allow light of specific wavelength to pass;
a mounting base to which the light emitting substrate is fixed and which includes a groove formed in an area overlapping the light emitting substrate;
an adhesive filled in the groove of the mounting base and cured by receiving the light of the specific wavelength; and
a lens condensing the light emitted from the light emitting substrate.

2. The optical head according to claim 1, wherein the mounting base includes a plurality of the grooves.

3. The optical head according to claim 2, wherein
the light emitting substrate extends in one direction, and
the plural grooves are arranged in a longitudinal direction of the light emitting substrate.

4. The optical head according to claim 1, wherein the mounting base has a through hole, one end of which is linked to the groove and the other end of which is present on a surface of the mounting base.

5. The optical head according to claim 4, wherein the mounting base includes a plurality of the through holes.

6. The optical head according to claim 1, wherein the light emitting substrate is formed of glass.

7. The optical head according to claim 1, wherein the light of the specific wavelength is an ultraviolet ray.

8. The optical head according to claim 1, wherein the mounting base includes:
plural blocks having the groove and supporting the light emitting substrate; and
a supporting plate supporting the plural blocks.

9. The optical head according to claim 8, wherein the blocks extend in a direction orthogonal to the supporting plate.

10. The optical head according to claim 8, wherein the plural blocks move in a same direction with respect to the supporting plate.

11. The optical head according to claim 8, wherein the mounting base includes screws fixing the blocks to the supporting plate.

12. An image forming apparatus comprising:
a photoconductive member;
a light emitting substrate emitting light and allow light of specific wavelength to pass;
a mounting base to which the light emitting substrate is fixed and which includes a groove formed in an area overlapping the light emitting substrate;
an adhesive filled in the groove of the mounting base and cured by receiving the light of the specific wavelength;
a lens leading the light, which is emitted from the light emitting substrate, to the photoconductive member and expose the photoconductive member to the light; and
a developing device supplying a developer to an exposed surface of the photoconductive member.

13. The apparatus according to claim 12, wherein the mounting base includes a plurality of the grooves.

14. The apparatus according to claim 12, wherein
the light emitting substrate extends in one direction, and
the plural grooves are arranged in a longitudinal direction of the light emitting substrate.

15. The apparatus according to claim 12, wherein the mounting base has a through hole, one end of which is linked to the groove and the other end of which is present on a surface of the mounting base.

16. The apparatus according to claim 12, wherein the mounting base includes a plurality of the through holes.

17. The apparatus according to claim 12, wherein the light emitting substrate is formed of glass.

18. The apparatus according to claim 12, wherein the light of the specific wavelength is an ultraviolet ray.

19. A method of manufacturing an optical head, comprising:
placing, on a mounting base, a light emitting substrate emitting light;
filling an adhesive in a groove formed in an area overlapping the light emitting substrate in the mounting base by using a through hole that links the groove and a surface of the mounting base; and
curing the adhesive by receiving an ultraviolet ray that passes through the light emitting substrate and reaches the adhesive in the groove.
